(19) United States
(12) Patent Application Publication
(10) Pub. No.: US 2015/0220256 A1
(43) Pub. Date: Aug. 6, 2015

(54) DISPLAY APPARATUS AND CONTROL METHOD OF THE SAME

(71) Applicant: Samsung Electronics Co., Ltd., Suwon-si (KR)

(72) Inventors: Eun-mee SHIN, Yongin-si (KR); Keum-koo LEE, Yongin-si (KR); Hye-won LEE, Anyang-si (KR); Chul-ho HAN, Seoul (KR)

(21) Appl. No.: 14/586,161

(22) Filed: Dec. 30, 2014

(30) Foreign Application Priority Data
Feb. 6, 2014 (KR) 10-2014-0013565

(51) Int. Cl. G06F 3/0484; H04M 1/725; G06F 3/0481

(52) U.S. Cl. CPC G06F 3/04845; G06F 3/0481; G06F 3/04842; H04M 1/72522

(57) ABSTRACT

A display apparatus is provided. The display apparatus includes a display configured to display an image, a command receiver configured to receive a user's command with regard to the image, and a controller configured to determine at least one correlated point included in the image by analyzing the image, to display an area corresponding to the at least one determined correlated point on the displayed image, and to control the display to display a search result corresponding to a correlated point of an area selected in accordance with the user's command among the areas corresponding to the at least one correlated point.

### CROSS-REFERENCE TO RELATED APPLICATION(S)

This application claims the benefit under 35 U.S.C. §119(a) of a Korean patent application filed on Feb. 6, 2014 in the Korean Intellectual Property Office and assigned Serial number 10-2014-0013565, the entire disclosure of which is hereby incorporated by reference.

### TECHNICAL FIELD

The present disclosure relates to a display apparatus and a control method of the same. More particularly, the present disclosure relates to a display apparatus which provides a search result corresponding to a partial region on an image, and a control method of the same.

### BACKGROUND

To search for a desired image on the World Wide Web, a method for searching the image through a keyword search related to the image has generally been used according to the related art. In the case of a smart phone being currently used, a photo album function is provided to sort stored photos to be searched in accordance with dates and time, or to search the stored photo according to categories.

However, in the smart phone, or the like, where a massive amount of photos are stored, it is difficult to find a desired photo, and there is no easy way to search photos of a specific person or to search photos taken in the past.

Besides, in the case of the photo search based on an image, there has been proposed a method for searching the same photo as the corresponding image, but this method has a limit in technical accuracy. In addition, inaccuracy in the search may cause a user to lose expectation and have a psychological refusal, thereby decreasing usage.

Therefore, a need exists for a display apparatus and a control method of the same, which displays an area corresponding to at least one correlated point included in an image, and provides a search result corresponding to the correlated point of the selected area, thereby enabling various related searches with regard to the image.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a display apparatus and a control method of the same, which displays an area corresponding to at least one correlated point included in an image, and provides a search result corresponding to the correlated point of the selected area, thereby enabling various related searches with regard to the image.

In accordance with an aspect of the present disclosure, a display apparatus is provided. The display apparatus includes a display configured to display an image, a command receiver configured to receive a user's command with regard to the image, and a controller configured to determine at least one correlated point included in the image by analyzing the image, to display an area corresponding to the at least one determined correlated point on the displayed image, and to control the display to display a search result corresponding to a correlated point of an area selected in accordance with the user's command among the areas corresponding to the at least one correlated point.

The correlated point may include at least one piece of information about a face, an object, a pattern, a color, a time and a place within the image.

The correlated point may be related to the time, and the controller may gradually display a plurality of search results in units of time whenever the plurality of user's commands are received, respectively.

The controller may display time information corresponding to the search result.

The search result may include at least one of a still image, a moving image, a text and a web page.

If there is a plurality of search results, the controller may display the search result having higher similarity with the correlated point of the selected area.

If there is a plurality of correlated points corresponding to the selected area, the controller may display the search result corresponding to the correlated point selected in accordance with the user's command among the plurality of correlated points.

The user's command may include a control command with regard to the selected area, and the controller may select one correlated point among the plurality of correlated points in accordance with the control command.

The display may display a User Interface (UI) item for guiding input of the control command.

If the search result is an image, the controller may display an area corresponding to at least one correlated point among the plurality of correlated points with regard to the search result.

The controller may display a UI for previously showing a search result corresponding to the selected area.

In accordance with another aspect of the present disclosure, a method for controlling a display apparatus, the method is provided. The method includes displaying an image, determining at least one correlated point included in the image by analyzing the image, displaying an area corresponding to the at least one determined correlated point on the displayed image, and displaying a search result corresponding to a correlated point of an area selected in accordance with a user's command among the areas corresponding to the at least one correlated point.

The correlated point may include at least one piece of information about a face, an object, a pattern, a color, a time and a place within the image.

The correlated point may be related to the time, the method further including gradually displaying a plurality of search results in units of time whenever the plurality of user's commands are received, respectively.

The method may further include displaying time information corresponding to the search result.

The search result may include at least one of a still image, a moving image, a text, and a web page.

The displaying the search result may include, if there is a plurality of search results, displaying the search result having higher similarity with the correlated point of the selected area.

The displaying the search result may include, if there is a plurality of correlated points corresponding to the selected area, displaying the search result corresponding to the correlated point selected in accordance with the user's command among the plurality of correlated points.

The user's command may include a control command with regard to the selected area, the method further including selecting one correlated point among the plurality of correlated points in accordance with the control command.

The method may further include displaying a UI item for guiding input of the control command.

The displaying the search result may include, if the search result is an image, displaying an area corresponding to at least one correlated point among the plurality of correlated points with regard to the search result.

The displaying the search result may include displaying a UI for previously showing a search result corresponding to the selected area.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above other aspects, features, and advantages of certain embodiments of the present disclosure will be more apparent from the following description taken in conjunction with the accompanying drawings, in which:

FIG. 1 is a block diagram of a display apparatus according to an embodiment of the present disclosure;

FIG. 2 illustrates operations in a display apparatus according to an embodiment of the present disclosure;

FIG. 3 illustrates operations in a display apparatus according to an embodiment of the present disclosure;

FIG. 4 illustrates operations in a display apparatus if a plurality of correlated points corresponds to a selected area according to an embodiment of the present disclosure;

FIG. 5 illustrates operations in a display apparatus if a plurality of correlated points corresponds to a selected area according to an embodiment of the present disclosure; and

FIG. 6 is a flowchart illustrating a control method of a display apparatus according to an embodiment of the present disclosure.

Throughout the drawings, it should be noted that like reference numbers are used to depict the same or similar elements, features, and structures.

### DETAILED DESCRIPTION

The following description with reference to accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

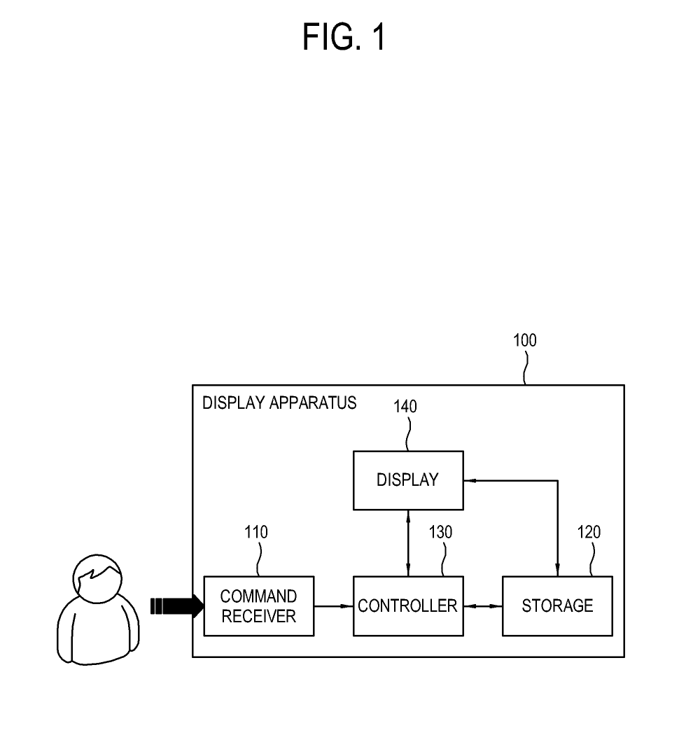

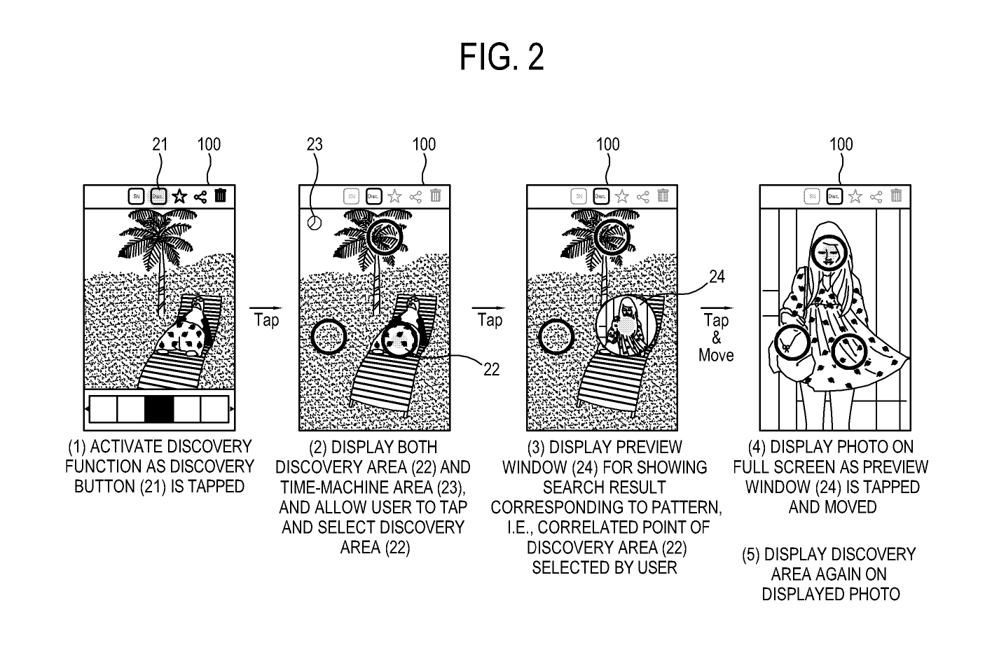

Below, elements included in a display apparatus will be first described with reference to FIG. 1 together with FIGS. 2, 3, 4, and 5 as necessary.

FIG. 1 is a block diagram of a display apparatus according to an embodiment of the present disclosure.

Referring to FIG. 1, the display apparatus 100 includes a command receiver 110, a storage 120, a controller 130, and a display 140. For example, the display apparatus 100 may be achieved by a smart phone, a Television (TV), a Personal Computer (PC), a notebook computer, a tablet computer, and the like. The display apparatus 100 first displays an image, and analyzes the displayed image, thereby determining at least one correlated point included in the image. The display apparatus 100 displays area corresponding to at least one correlated point determined on the displayed image, and displays a search result corresponding to the correlated point of the area selected in accordance with a user's command on the display 140. Thus, the display apparatus 100 includes the area corresponding to at least one correlated point included in the image, and provides the search result corresponding to the correlated point of the selected area, thereby having an advantage of enabling various related searches with respect to the image.

The display 140 displays an image. The image may be at least one of an image of a photo displayed on the display apparatus 100, a content image, and an image on the World Wide Web. There is no limit to the realization of the display 140. For example, the display 140 may be provided in the form of a Plasma Display Panel (PDP), a Liquid Crystal Display (LCD), an Organic Light Emitting Diode (OLED), a flexible display, and the like.

The command receiver 110 receives a user's command with regard to the image. The user's command is a user's command for selecting the area corresponding to the correlated point included in the image displayed on the display 140, which may include a command by hand, such as tap, move, scroll, and the like, and a command by an input device, such as a mouse, a keyboard, and the like.

The storage 120 stores an image displayed on the display 140, and an image acquired by a phone camera mounted to the display apparatus 100, a webcam, or an external camera. In addition, the storage 120 may store at least one correlated point included in the image, together with the image.

Here, the correlated point may include at least one piece of information about a face, an object, a pattern, a color, a time and a place within the image. For example, if a photo is taken by the smart phone, the smart phone may store not only the photo but also face information, object information, and certain pattern and color information about person included in the photo. In addition, the storage 120 may store information about a date and a time of when the photo is taken, and information about a place where the photo is taken. Here, the correlated point included in the image, which can be stored in the storage 120, is not limited to the various embodiments set forth herein, but may include various pieces of information about the image.

The controller 130 analyzes the image and determines at least one correlated point included in the image. Here, the correlated point may include at least one piece of information about a face, an object, a pattern, a color, a time and a place. The controller 130 controls the display 140 to display the area corresponding to at least one determined correlated point on the displayed image, and display a search result corresponding to the correlated point of the area selected in accordance with the user's command among the areas corresponding to at least one correlated point. If there is a plurality of search results, the controller 130 may display the search result having higher similarity with the correlated point of the selected area. For instance, if the correlated point of the selected area is the face information, a face of a human or animal is recognized in the selected area, and then photos involving an object recognized as it is similar to the face information are displayed as the search result. In addition, if the correlated point of the selected area is the object information, photos involving an object equivalent to a recognizable object (e.g., a vehicle, a bicycle, a mountain, a tree, and the like) of the selected area are displayed as the search result. Further, if the correlated point of the selected area is the pattern information, photos involving an object recognized as a design and style similar to a pattern of the selected area are displayed as the search results. Furthermore, if the correlated point of the selected area is the color information, photos having chroma and brightness similar to those of the selected area are displayed as the search results. In addition, the search result may include at least one of an image, a moving image, a text, a web page, and the like.

FIG. 2 illustrates operations in a display apparatus according to an embodiment of the present disclosure.

Referring to FIG. 2, a user may activate a discovery function in the display apparatus 100, such as the smart phone, in order to do various related searches with respect to the photo that s/he is watching. If a user taps a discovery button 21 to activate the discovery function, the controller 130 displays at least one discovery area 22 and a time-machine area 23, which are selectable by him/her, on the photo. At this time, the displayed discovery area 22 refers to an area corresponding to the correlated point, such as a face, an object, a pattern, a color, and the like, involved in the photo, and the time-machine area 23 refers to an area corresponding to the correlated point, such as a date and time about the photo.

If a user taps and selects the discovery area 22 in at least one area displayed on the photo, the controller 130 displays the search result corresponding to the pattern, i.e., the correlated point of the selected discovery area 22 in the form of a preview window 24 having a certain size. The preview window 24 may be achieved by a User Interface (UI) having a certain size, which can previously show the search results. At this time the controller 130 searches a photo having the highest similar pattern as the correlated point, i.e., the pattern of the selected discovery area 22, and displays it as the search result. Such a search result may be acquired from the photos previously stored in the storage 120, and correlated point information of the photo. Alternatively, the controller 130 may display at least one of the correlated moving image, text and web page besides the image, such as the photo, as the search results. For example, a moving-image content having the most similar pattern to the pattern, i.e., the correlated point of the selected discovery area 22 may be displayed as the search result. Further, a text, such as a purchase list, an order e-mail, and the like, of products purchased by a user in a shopping mall and having the similar pattern may be displayed as the search result. In addition, a photo and a web page showing related product information may be displayed as the search result.

The controller 130 may display the search result on a full screen when the preview window 24 showing the search result corresponding to the correlated point of the selected discovery area 22 is tapped and moved. If the search result is an image, the controller 130 may display the area corresponding to at least one correlated point again with respect to the displayed search result. For example, the photo involving the similar pattern is displayed as the search result, and the area corresponding to the correlated point, such as a face, an object, a pattern, a color, a time, a place, and the like, is further displayed on the displayed photo.

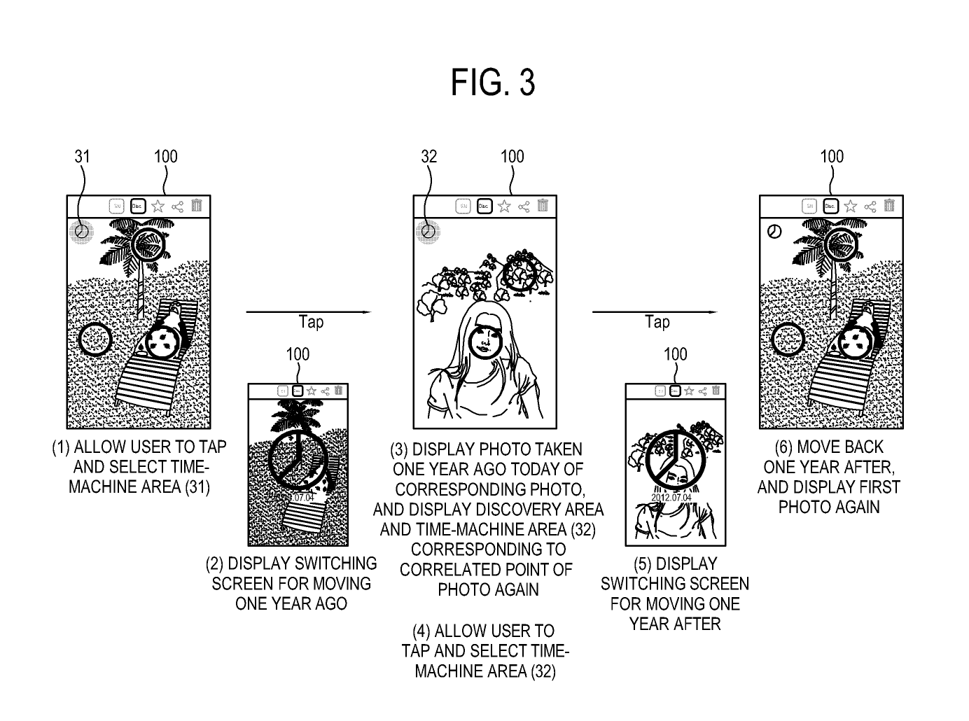

FIG. 3 illustrates operations in a display apparatus according to an embodiment of the present disclosure.

Referring to FIG. 3, if a user taps the discovery button in the smart phone and activates the discovery function, the controller 130 displays at least one discovery area and a time-machine area 31, which are selectable by a user, on the photo. If a user selects and taps the time-machine area 31 among at least one area displayed on the photo, the controller 130 may display a photo taken one year ago today as the search result corresponding to a date and a time, i.e., the correlated point of the selected time-machine area 31. If there is no photo taken one year ago today, a photo stored on the nearest date to one year ago today may be displayed. Alternatively, units of time for searching may be varied. For example, not the photo taken one year ago today but a photo taken six months ago may be displayed. The controller 130 may display the photo taken one year ago as the search result, and further display a discovery area and a time-machine area 32 with respect to the displayed photo. At this time, if a user taps and selects the time-machine area 32, the controller 130 returns to one year after and displays the first displayed photo. Before displaying the photo taken one year ago today or displaying the first displayed photo again, the controller 130 may display a switching screen for informing a time shift, and at this time display corresponding time information together with the switching screen.

According to another embodiment of the present disclosure, if the correlated point is time information, the controller 130 may gradually display a plurality of search results in units of time whenever the plurality of user's commands are received, respectively. For example, a photo taken one year ago today may be displayed with regard to the selected area in accordance with the user's command, and a photo taken one year ago date with respect to the displayed photo may be displayed again in accordance with the user's command. Accordingly, if a user wants to sequentially do the time related searches with regard to the photo, the past photos may be gradually displayed in units of time. At this time the controller 130 may display time information corresponding to the search result.

Meanwhile, if there is a plurality of correlated points corresponding to the selected area, the controller 130 displays the search result corresponding to the correlated point selected in accordance with the user's command among the plurality of correlated points. Here, the user's command includes a control command with regard to the selected area, and the control command may include tap and move; up, down, left and right scroll, and the like. The controller 130 may select one correlated point among the plurality of correlated points in accordance with the control command, and at this time the display 140 may display a UI item for guiding input of the control command.

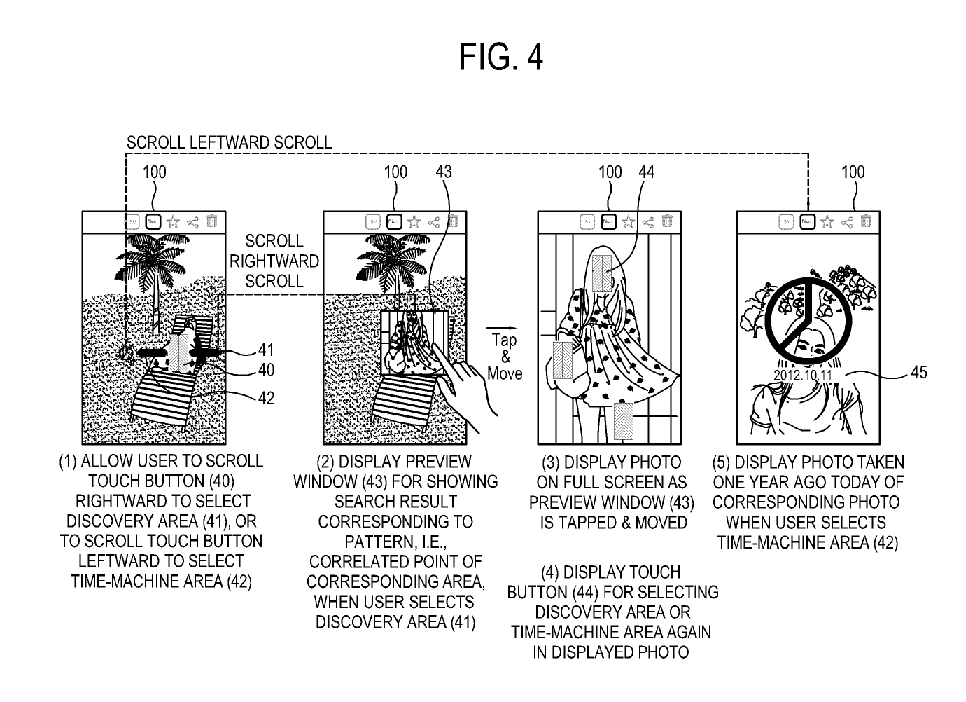

FIG. 4 illustrates operations in a display apparatus if a plurality of correlated points corresponds to a selected area according to an embodiment of the present disclosure.

Referring to FIG. 4, if a user taps the discovery button in the smart phone and activates the discovery function, the controller 130 displays at least one touch button 40, which can be selected by a user, on the photo. If the plurality of correlated points corresponds to the area where the touch button 40 is displayed, the correlated point is selected by a user's control command with regard to the touch button 40. A user may select a discovery area 41 corresponding to the pattern among the correlated points by a control command of scrolling the touch button 40 rightward, and may select a time-machine area 42 corresponding to the time among the correlated points by a control command of scrolling leftward the touch button 40. If a user selects discovery area 41 by scrolling the touch button 40 rightward, the controller 130 may display a search result corresponding to the pattern, i.e., the correlated point of the selected discovery area 41 in a preview window 43 having a certain size. Here, the preview window 43 may be achieved by a UI having a certain size enough to previously show the search result. By tapping and moving the preview window 43, the search result may be displayed on the full screen. If the search result is an image, the controller 130 may display a touch button 44 for allowing the discovery area and the time-machine area to be selected again corresponding to at least one correlated point with respect to the displayed search result.

Further, if a user selects the time-machine area 42 by scrolling the touch button 40 leftward, the controller 130 may display a photo taken one year ago today from a current photo as a search result corresponding to a date and a time, i.e., the correlated point of the selected time-machine area 42. In displaying the search result, if there is no photo taken one year ago today, a photo stored on the nearest date to one year ago today may be displayed. In addition, units of time for searching may be varied. For example, the photo taken not one year ago today but six months ago may be displayed. The controller 130 may display the photo taken one year ago today, together with time information 45 showing a corresponding date or the like.

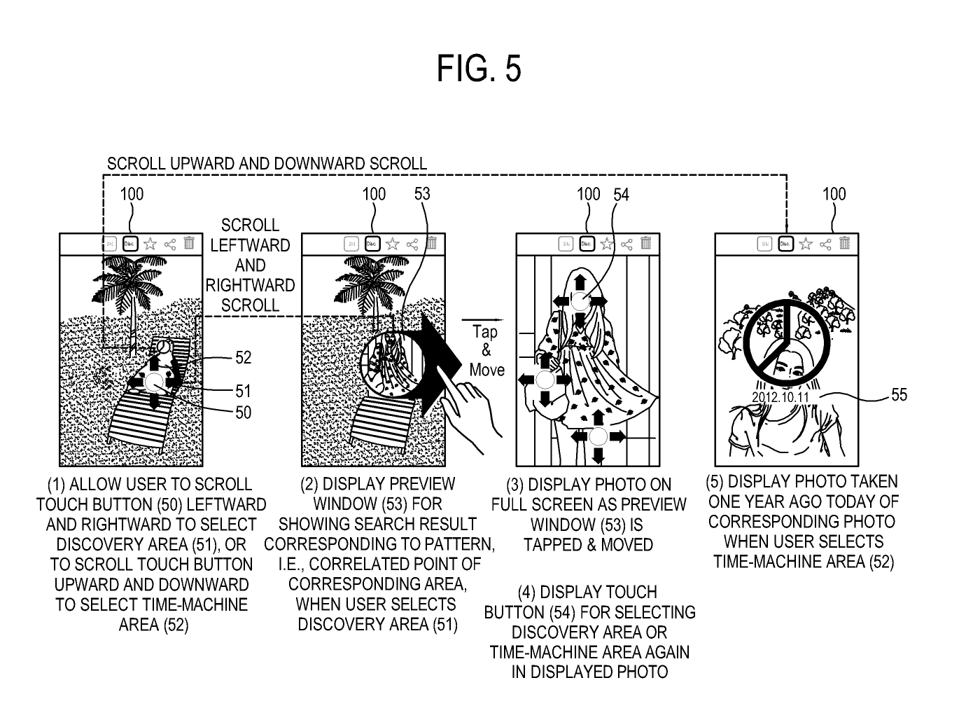

FIG. 5 illustrates operations in a display apparatus if a plurality of correlated points corresponds to a selected area according to an embodiment of the present disclosure.

Referring to FIG. 5, if a user taps the discovery button and activates the discovery button in the smart phone, the controller 130 displays at least one touch button 50 selectable by a user on a photo. If a plurality of correlated points corresponds to an area where a touch button 50 is displayed, the correlated point may be selected by a user's control command with regard to the touch button 50. A user may select a discovery area 51 corresponding to the pattern among the correlated points by the control command of scrolling the touch button 50 leftward or rightward, and select a time-machine area 52 corresponding to the time among the correlated points by the control command of scrolling the touch button 50 upward or downward. If a user selects the discovery area 51 by scrolling the touch button 50 leftward or rightward, the controller 130 may display the search result corresponding to the pattern, i.e., the correlated point of the selected discovery area 51 in a preview window 53 having a certain size. By tapping and moving the preview window 53, the search result may be displayed on the full screen. If the search result is an image, the controller 130 may display a touch button 54 for allowing the discovery area and the time-machine area to be selected again corresponding to at least one correlated point with respect to the displayed search result. Further, if a user selects the time-machine area 52 by scrolling the touch button 50 upward or downward, the controller 130 may display a photo taken one year ago today from a current photo as a search result corresponding to a date and a time, i.e., the correlated point of the selected time-machine area 52. The controller 130 may display the photo taken one year ago today, together with time information 55 showing a corresponding date or the like.

Further, a user may scroll the touch button 50 rightward to display a similar photo corresponding to the pattern among the correlated points, and scroll the touch button 50 leftward to display a similar photo corresponding to the object among the correlated points. In addition, a user may scroll the touch button 50 upward to display a photo taken one year ago today, and may scroll the touch button 50 downward to display a photo taken six months ago. Accordingly, the correlated point may be differently selected in accordance with a user's control command regarding the selected area.

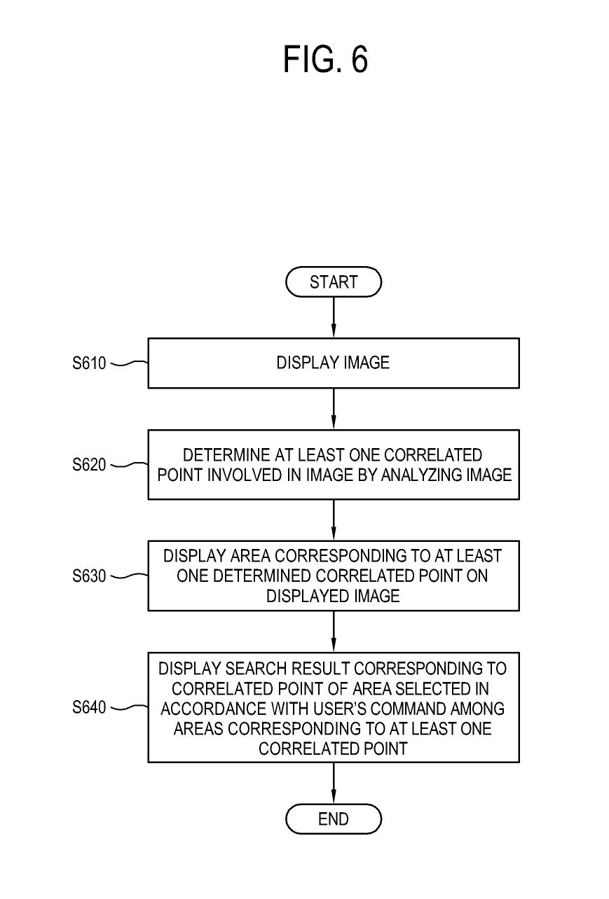

FIG. 6 is a flowchart illustrating a control method of a display apparatus according to an embodiment of the present disclosure.

Referring to FIG. 6, an image is first displayed at operation S610, and analyzed to determine at least one correlated point involved therein at operation S620. Here, the correlated point may include at least one piece of information about a face, an object, a pattern, a color, a time and a place within the image.

Thereafter, at operation S630, the area corresponding to at least one determined correlated point is displayed on the displayed image. Last, at operation S640, a search result corresponding to an area selected in accordance with a user's command among the areas corresponding to at least one correlated point is displayed on the display. The search result may include at least one of the image, the moving image, the text and the web page. Here, the operation S640 of displaying the search result on the display may include an operation of displaying the search result having higher similarity with the correlated point of the selected area if there is a plurality of search results. In addition, the operation S640 of displaying the search result on the display may include an operation of displaying a UI for previously showing a search result corresponding to the selected area. For example, as shown in FIG. 2, the search result corresponding to the pattern, i.e., the correlated point of the discovery area 22 selected by a user may be displayed in the preview window 24. At this time, the search result displayed in the preview window 24 may be tapped and moved by a user to displayed on the full screen, or may be stopped while being tapped and moved to thereby cancel the display on the full screen.

According to an embodiment of the present disclosure, if the correlated point of the selected area is related to the time, there is further provided an operation of gradually displaying a plurality of search results related in units of time whenever the plurality of user's commands are received, respectively. For example, if a search corresponding to the correlated point about the time is tried with respect to the selected area of the photo, a photo taken one year ago today is displayed, and a photo taken one year ago today from the displayed photo is searched and displayed again, thereby gradually displaying the search results. At this time, units of time for searching may be varied without any limitation to this embodiment.

The operation S640 of displaying the search result on the display may include an operation of displaying the search result corresponding to the selected correlated point in accordance with a user's command among the plurality of correlated points if the plurality of correlated points corresponds to the selected area. At this time, the user's command includes a control command with regard to the selected area, and there may be provided an operation of selecting one correlated point among the plurality of correlated points in accordance with the control command. In addition, there may be provided an operation of displaying a UI item for guiding input of the control command. For example, as shown in FIG. 4, if the correlated points of the pattern and time correspond to the area where the touch button 40 is displayed, the search result corresponding to the pattern or time may be displayed in accordance with a user's control command of scrolling the touch button 40 rightward or leftward. Alternatively, as shown in FIG. 5, if the correlated points of the pattern, object and time correspond to the area where the touch button 50 is displayed, the search results corresponding to one year ago, six months ago, an object and a pattern may be respectively displayed in accordance with a user's control commands of scrolling the touch button 50 upward, downward, leftward and rightward.

As described above, according to an embodiment of the present disclosure, the area corresponding to at least one correlated point involved in the image is displayed, and the search result corresponding to the correlated point of the selected area is provided, thereby making it possible to perform various related searches with respect to the image.

While the present disclosure has been shown and described with reference to various embodiments thereof, it will be understood by those skilled in the art that various changes in form and details may be made therein without departing from the spirit and scope of the present disclosure, as defined by the appended claims and their equivalents.

What is claimed is:

1. A display apparatus comprising:
a display configured to display an image;
a command receiver configured to receive a user's command with regard to the image; and
a controller configured:
to determine at least one correlated point included in the image by analyzing the image,
to display an area corresponding to the at least one determined correlated point on the displayed image, and
to control the display to display a search result corresponding to a correlated point of an area selected in accordance with the user's command among the areas corresponding to the at least one correlated point.

2. The display apparatus of claim 1, wherein the at least one correlated point comprises at least one piece of information about a face, an object, a pattern, a color, a time and a place within the image.

3. The display apparatus of claim 2,
wherein the at least one correlated point is related to the time, and
wherein the controller is further configured to gradually display a plurality of search results in units of time whenever a plurality of user's commands are received.

4. The display apparatus of claim 3, wherein the controller is further configured to display time information corresponding to the search result.

5. The display apparatus of claim 1, wherein the search result comprises at least one of a still image, a moving image, a text and a web page.

6. The display apparatus of claim 1, wherein, if there is a plurality of search results, the controller is further configured to display the search result having higher similarity with the at least one correlated point of the selected area.

7. The display apparatus of claim 1, wherein, if there is a plurality of correlated points corresponding to the selected area, the controller is further configured to display the search result corresponding to the at least one correlated point selected in accordance with the user's command among the plurality of correlated points.

8. The display apparatus of claim 7,
wherein the user's command comprises a control command with regard to the selected area, and
wherein the controller is further configured to select one correlated point among the plurality of correlated points in accordance with the control command.

9. The display apparatus of claim 8, wherein the display is further configured to display a User Interface (UI) item for guiding input of the control command.

10. The display apparatus of claim 1, wherein, if the search result is an image, the controller is further configured to display an area corresponding to at least one correlated point among the plurality of correlated points with regard to the search result.

11. The display apparatus of claim 1, wherein the controller is further configured to display a User Interface (UI) for previously showing a search result corresponding to the selected area.

12. The display apparatus of claim 2, wherein, if a user taps a discovery button on the display to activate a discovery function, the controller is further configured to display at least one selectable discovery area and a selectable time-machine area.

13. The display apparatus of claim 12,
wherein the displayed discovery area indicates an area corresponding to at least one of a face, an object, a pattern, a color, and
wherein the time-machine area indicates an area corresponding to at least one of a date and time about the photo.

14. A method for controlling a display apparatus, the method comprising:
displaying an image;
determining at least one correlated point included in the image by analyzing the image;
displaying an area corresponding to the at least one determined correlated point on the displayed image; and
displaying a search result corresponding to a correlated point of an area selected in accordance with a user's command among the areas corresponding to the at least one correlated point.

15. The method of claim 14, wherein the at least one correlated point comprises at least one piece of information about a face, an object, a pattern, a color, a time and a place within the image.

16. The method of claim 15,
wherein the at least one correlated point is related to the time, and
wherein the method further comprises gradually displaying a plurality of search results in units of time whenever a plurality of user's commands are received, respectively.

17. The method of claim 16, further comprising displaying time information corresponding to the search result.

18. The method of claim 14, wherein the search result comprises at least one of a still image, a moving image, a text and a web page

19. The method of claim 14, wherein the displaying of the search result comprises, if there is a plurality of search results, displaying the search result having higher similarity with the at least one correlated point of the selected area.

20. The method of claim 14, wherein the displaying of the search result comprises, if there is a plurality of correlated points corresponding to the selected area, displaying the search result corresponding to the at least one correlated point selected in accordance with the user's command among the plurality of correlated points.

21. The method of claim 20,
wherein the user's command comprises a control command with regard to the selected area, and
wherein the method further comprises selecting one correlated point among the plurality of correlated points in accordance with the control command.

22. The method of claim 21, further comprising displaying a User Interface (UI) item for guiding input of the control command.

23. The method of claim 14, wherein the displaying of the search result comprises, if the search result is an image, displaying an area corresponding to at least one correlated point among the plurality of correlated points with regard to the search result.

24. The method of claim 14, wherein the displaying of the search result comprises displaying a User Interface (UI) for previously showing a search result corresponding to the selected area.

25. The method of claim 15, further comprising:
if a user taps a discovery button on the display to activate a discovery function, displaying at least one selectable discovery area and a selectable time-machine area.

26. The method of claim 25,
wherein the displayed discovery area indicates an area corresponding to at least one of a face, an object, a pattern, a color, and
wherein the time-machine area indicates an area corresponding to at least one of a date and time about the photo.
